(19) United States
(12) Patent Application Publication
(10) Pub. No.: US 2014/0080593 A1
(43) Pub. Date: Mar. 20, 2014

(54) Gaming System and Method With Juxtaposed Mirror and Video Display

(71) Applicant: WMS GAMING, INC., Waukegan, IL (US)

(72) Inventors: Carlos Enrique Breban Rivera, Chicago, IL (US); Anthony Joseph Walter Prohl, Romeoville, IL (US); John Lawrence Walsh, Gurnee, IL (US); David Michael Mann, Chicago, IL (US); Timothy Carl Loose, Chicago, IL (US)

(73) Assignee: WMS GAMING, INC., Waukegan, IL (US)

(21) Appl. No.: 13/622,633

(22) Filed: Sep. 19, 2012

(51) Int. Cl. A63F 13/00

(52) U.S. Cl. 463/31

(57) ABSTRACT

A gaming system includes a motion tracking sensing device, a user image reproduction device to display a mirror image of a user operating the gaming system, a user image enhancement display device disposed in proximity to the user image reproduction device, and one or more memory devices storing instructions. The instructions cause the gaming system to sense, via the motion tracking sensing device, a first relative position of the user, generate first graphical images and first graphical image locations based on the sensed first relative position of the user, and output the first graphical images at the first graphical image locations on the user image enhancement display device so that the graphical images overlay corresponding portions of the mirror image of the user when viewed from the sensed first relative position of the user.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to a system having a juxtaposed mirror and video display to enhance a player's reflected image with accessories and symbols for enhanced game play.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

Typical gaming machines have game play using consistent images that are independent of the physical characteristics of the players of the gaming machines. Consequently, each player has a consistent, relatively generic game play experience. Current gaming machines are generally not equipped with hardware and software functionality where the physical characteristics of the player can be captured and integrated into the game play offered at the gaming machine to provide a tailored game play experience for the player. In view of this, a need exists for enhanced gaming machines providing a customized game play experience reflecting certain characteristics of the players using the gaming machines to provide a tailored gaming experience for each player.

### SUMMARY OF THE INVENTION

According to one aspect of the present invention, a gaming system comprises a motion tracking sensing device, a user image reproduction device configured to display a minor image of a user operating the gaming system, a user image enhancement display device disposed in proximity to the user image reproduction device, and one or more memory devices storing instructions. The instructions, when executed by one or more processors, cause the gaming system to sense, via the motion tracking sensing device, a first relative position of the user, generate first graphical images and first graphical image locations based on the sensed first relative position of the user, and output the first graphical images at the first graphical image locations on the user image enhancement display device so that the graphical images overlay corresponding portions of the mirror image of the user when viewed from the sensed first relative position of the user.

According to another aspect of the invention, a computer-implemented method in a gaming system comprises displaying a minor image of a user operating the gaming system on a user image reproduction device of the gaming system, sensing, via an input device, a first relative position of the user, generating, by one or more processors, first graphical images and first graphical image locations based on the sensed first relative position of the user, and outputting the first graphical images at the first graphical image locations at an output device so that the graphical images overlay corresponding portions of the minor image of the user when viewed from the sensed first relative position of the user.

According to yet another aspect of the invention, a gaming system comprises a mirror for displaying a mirror image of a user operating the gaming system, a motion tracking sensing device, a user image enhancement display device disposed in proximity to the minor, and one or more memory devices storing instructions. The instructions, when executed by one or more processors, cause the gaming system to sense, via the motion tracking sensing device, a first relative position of the user, generate first graphical images and first graphical image locations based on the sensed first relative position of the user, and output the first graphical images at the first graphical image locations on the user image enhancement display device so that the graphical images overlay corresponding portions of the minor image of the user when viewed from the sensed first relative position of the user.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming terminal according to an embodiment of the present invention.

FIG. 2 is a schematic view of a gaming system according to an embodiment of the present invention.

FIG. 3 is an image of an exemplary basic-game screen of a wagering game displayed on a gaming terminal, according to an embodiment of the present invention.

FIG. 4 is a front view of a gaming terminal having a secondary display area in accordance with the present disclosure.

FIG. 5 is a right side view of the gaming terminal of FIG. 4 with a portion removed to reveal internal structure of a first embodiment of the secondary display area in accordance with the present disclosure.

FIG. 6 is a schematic perspective view of components of the secondary display area of FIG. 5 and a user of the gaming terminal in a user operating position.

FIG. 7 is a front view of the gaming terminal of FIG. 4 with a minor image of the user and overlaid graphics moving to the right.

FIG. 8 is a front view of the gaming terminal of FIG. 4 with a minor image of the user and overlaid graphics enlarging as the user moves toward the secondary display area.

FIG. 9 is a front view of the gaming terminal of FIG. 4 with a minor image of the user and overlaid graphics turned to the left.

FIG. 10 is a right side view of the gaming terminal of FIG. 4 with a portion removed to reveal internal structure of a further embodiment of the secondary display area in accordance with the present disclosure.

FIG. 11 is a schematic perspective view of components of the secondary display area of FIG. 10 and a user of the gaming terminal in a user operating position.

FIG. 12 is a schematic perspective view of the first and second display areas of the gaming terminal of FIG. 4 displaying mirror images of the user and overlaid graphics.

FIG. 13 is a front view of an upper portion of the gaming terminal of FIG. 4 with the secondary display area displaying a first embodiment of a bonus gaming in accordance with the present disclosure incorporating a mirror image of the user and overlaid graphics.

FIG. 14 is a front view of an upper portion of the gaming terminal of FIG. 4 with the secondary display area displaying the bonus gaming of FIG. 13 with an overlaid graphic fading to reveal a bonus award element.

FIG. 15 is a front view of an upper portion of the gaming terminal of FIG. 4 with the secondary display area displaying the bonus gaming of FIG. 13 with a bonus award element and updated bonus total graphics.

FIG. 16 is a front view of an upper portion of the gaming terminal of FIG. 4 with the secondary display area displaying the bonus gaming of FIG. 13 with an overlaid graphic fading to reveal an end game element graphic.

FIG. 17 is a front view of an upper portion of the gaming terminal of FIG. 4 with the secondary display area displaying the bonus gaming of FIG. 13 with an end game element graphic.

FIG. 18 is a front view of an upper portion of the gaming terminal of FIG. 4 with the secondary display area displaying an alternative embodiment of a bonus gaming in accordance with the present disclosure incorporating a mirror image of the user and accessory graphics.

FIG. 19 is a front view of an upper portion of the gaming terminal of FIG. 4 with the secondary display area displaying the bonus gaming of FIG. 18 with an accessory graphic fading out to reveal a bonus award element graphic and fading in as an overlaid graphic on the mirror image.

FIG. 20 is a front view of an upper portion of the gaming terminal of FIG. 4 with the secondary display area displaying the bonus gaming of FIG. 18 with a bonus award element, updated bonus total graphics and an accessory graphic overlaid on the mirror image.

FIG. 21 is a front view of an upper portion of the gaming terminal of FIG. 4 with the secondary display area displaying the bonus gaming of FIG. 18 with an accessory graphic fading out to reveal an end game element graphic and fading in as an overlaid graphic on the minor image.

FIG. 22 is a front view of an upper portion of the gaming terminal of FIG. 4 with the secondary display area displaying the bonus gaming of FIG. 18 with an end game element graphic and an accessory graphic overlaid on the mirror image.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

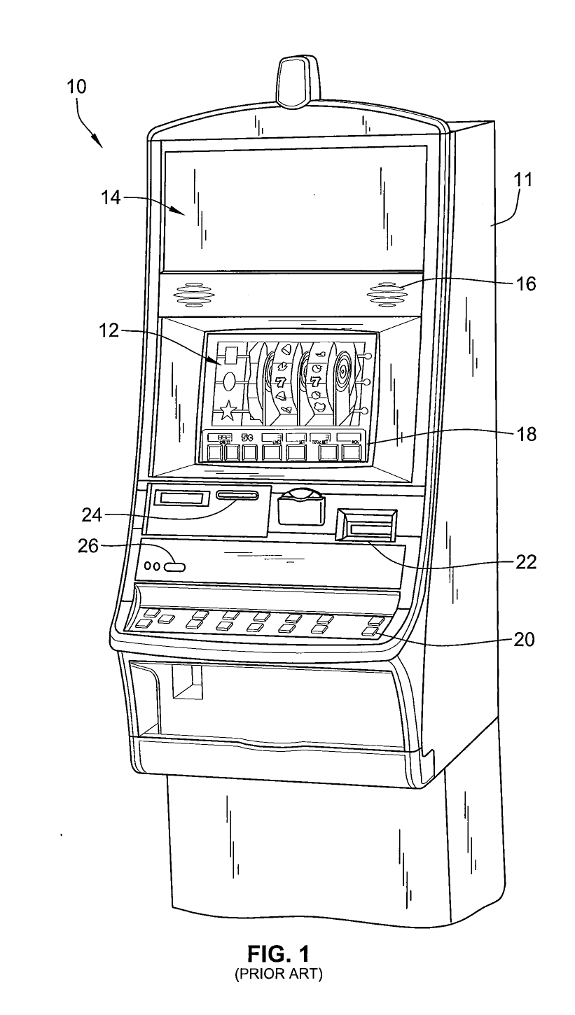

Referring to FIG. 1, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433 and Patent Application Publication Nos. US2010/0069160 and US2010/0234099, which are incorporated herein by reference in their entireties.

The gaming terminal 10 illustrated in FIG. 1 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 may include a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a central processing unit (CPU) for processing. The electronic data signals are selected from a group consisting essentially of an electrical current, an electrical voltage, an electrical charge, an optical signal, an optical element, a magnetic signal, and a magnetic element.

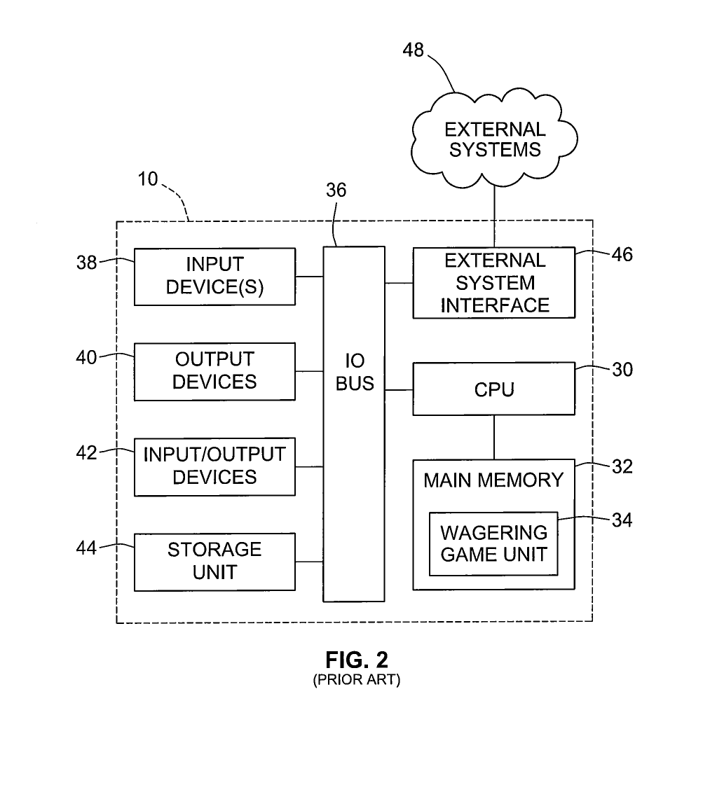

Turning now to FIG. 2, there is shown a block diagram of the gaming-terminal architecture. The gaming terminal 10 includes a CPU 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

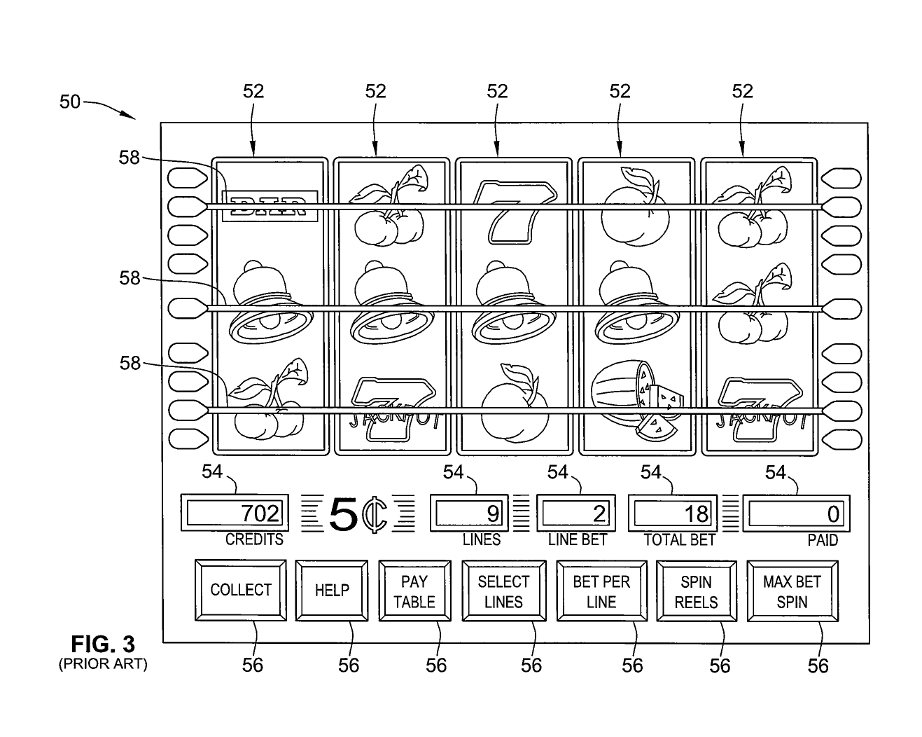

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving an input indicative of a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display area 12 or secondary display area 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display area 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

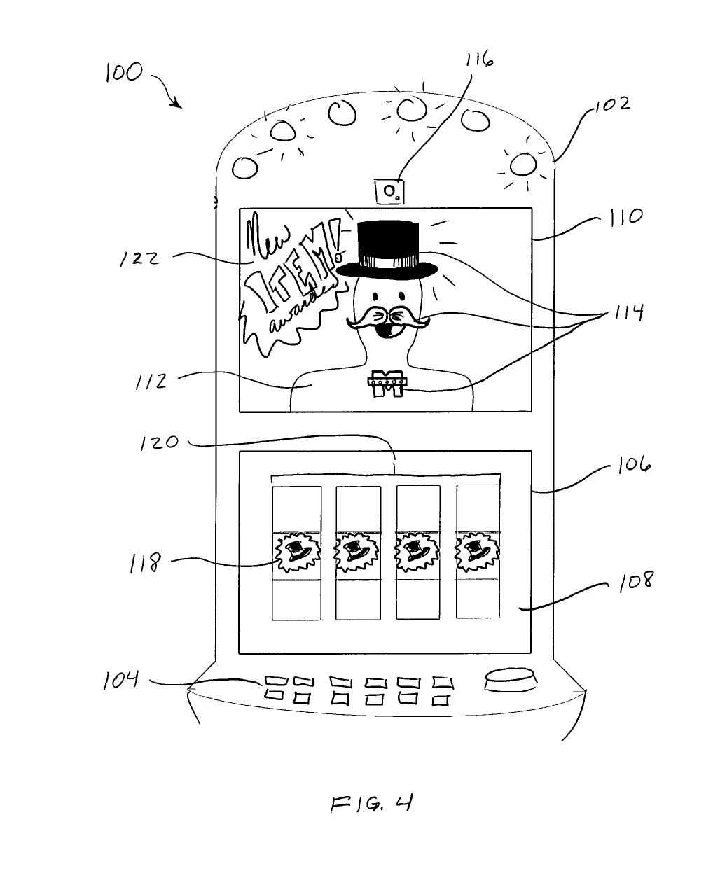

The user's game play experience with gaming systems in accordance with the present disclosure may be enhanced by providing game play content that is customized for each individual user. The customization and enhancement may be accomplished by interjecting the user's own image into the game and allowing the user to interact with their image during game play. Referring now to FIG. 4, a gaming terminal 100 may be generally similar to the gaming terminal 10 and includes a cabinet 102 supporting the components of the gaming terminal 100, such as buttons 104, a primary display area 106 that may be a touch screen 108, and a secondary display area 110 in accordance with the present disclosure that displays a minor image 112 of a user of the gaming terminal 100 with user image enhancing graphics 114.

The gaming terminal 100 further includes a motion tracking sensing device 116 aimed at a user operating position in front of the gaming terminal 100 at which the user should be disposed when playing games offered at the gaming terminal 100. The motion tracking sensing device 116 may be a sensing device of any appropriate motion tracking system utilizing technology such as that provided in the Kinect adjunct to Microsoft Corp.'s Xbox 360 gaming system, the Leap three-dimensional computer interaction system commercially marketed by Leap Motion of San Francisco, Calif., and the like, that senses the position, shape and movements of a user and converts the sensed user information into controls and graphics for execution and displaying a game or other programming functionality provided in the motion tracking system. In an exemplary implementation, a user may occupy the user operating position in front of the gaming terminal 100 to play a primary gambling game using inputs such as the buttons 104 and touch screen 108. Upon the occurrence of a bonus round triggering event in the primary wagering game, such as the occurrence of a specified bonus combination of reel symbols 118 on reels 120, the gaming terminal 100 may enter a bonus game mode in which a bonus game is displayed at the secondary display area 110. The bonus game display may include displaying the minor image 112 of the user with the user image enhancing graphics 114 overlaid, along with additional bonus game graphics 122. The information from the motion tracking sensing device 116 provides the position and orientation of the user to the CPU 30 so that the user image enhancing graphics 114 are overlaid in the appropriate position with respect to the minor image 112. The user performs the bonus game to completion using the buttons 104, touch screen 108 and/or if provided as a touch screen, the secondary display area 110, with the minor image 112 moving along with the user and the user image enhancing graphics 114 moving and reorienting with respect to the minor image 112 to maintain their proper positioning as viewed by the user from the user's position relative to the gaming terminal 100. When the bonus game is complete, the game action returns to the primary display area 106, and the mirror image 112 and graphics 114 may continue to be displayed, or be replaced on the secondary display area 110 by other graphics related to the primary wagering game or to attracting others to play the game.

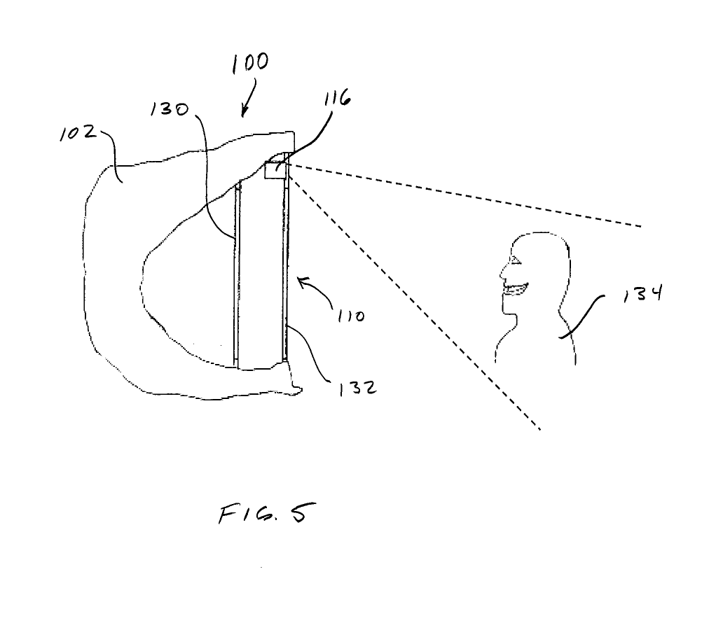

The user's image may be integrated into the game play at the gaming terminal 100 using a combination of a user image reproduction device for displaying the minor image 112 of the user, and a user image enhancement device for displaying the graphics 114 that partially overlay the mirror image 112 of the user. FIG. 5 partially illustrates one embodiment of the gaming terminal 100 wherein the user image reproduction device is a mirror 130 disposed within the cabinet 102, and the user image enhancement device is a flat panel transmissive video display 132 positioned in front of the mirror 130 at the surface of the secondary display area 110. The transmissive video display 132 may be, for example, a transmissive liquid crystal display (LCD) commercially available from LG Phillips LCD Co., Ltd., of Seoul, Korea, a transmissive organic light-emitting diode (OLED) commercially available from Sony Electronics, Inc., of San Diego, Calif., USA, or other type of video display capable of displaying images while allowing light to pass through for viewing objects positioned behind the transmissive video display 132. The transmissive video display 132 may also include a touch screen device (not shown) overlaid on the display 132 that can detect touches by users on the outer surface of the video display 132 within designated areas that are relevant to the execution of the game play, such as a bonus game, provided at the secondary display area 110. Alternatively, the touch screen functionality may be embedded or integrated into the display 132 as a single component.

The motion tracking sensing device 116 is mounted in the cabinet 102 above the secondary display area 110, but may be located at any appropriate location on the gaming terminal 100 to sense the presence and motion of a user 134. The motion tracking sensing device 116 is aimed at a user operating position in front of the gaming terminal 100 where the user 134 will be disposed when playing the wagering game. When the user 134 is present within the user operating position, the sensing information from the motion tracking sensing device 116 is output over the I/O bus 36 to the CPU 30 for interpretation and determination of the position, shape and orientation of the user 134. Based on this information, the CPU 30 executes motion tracking software stored at the main memory 32 to generate the user image enhancing graphics 114 and to determine the locations at which the graphics 114 will be positioned on the video display 132.

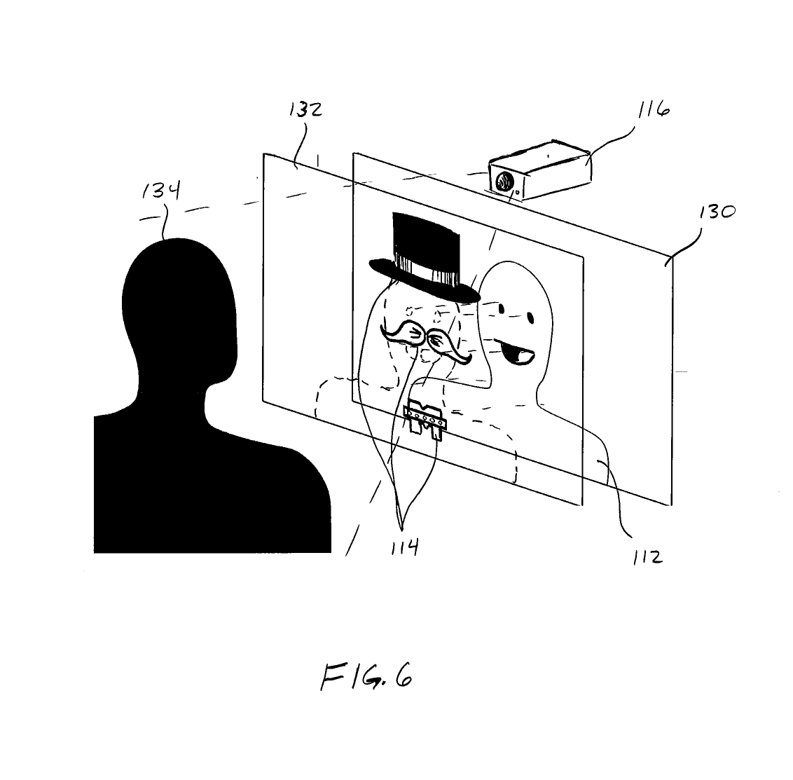

The generated graphics 114 and positions are output to the video display 132 and are overlaid on the mirror image 112 of the user 134 as shown in FIG. 6. Because the video display 132 is transmissive, the minor image 112 is visible to the user when no graphics are displayed by the video display 132. When the graphics 114 are displayed, the light of the graphics 114 overcomes or washes out the light reflected by the minor 130 into the areas occupied by the graphics 114 so that the graphics 114 appear to be disposed on the user's body. For example, a top hat may be disposed on the top of the user's head, a mustache may be disposed on the user's upper lip, and a tie may be placed on the user's collar. Other features and items may be added to the minor image 112. It may also be possible to enhance the mirror image 112 without completely covering the minor image 112. For example, the skin tone of the mirror image 112 may be changed by displaying a color overlaying the face and other exposed skin of the user 134 in the minor image 112, but with a relatively lower light intensity so that the features of the user 134 are visible through the color. Using this approach, the minor image 112 may be given a green skin tone to match the skin color of the Wicked Witch of the West by displaying a low light intensity green color overlaying the minor image 112.

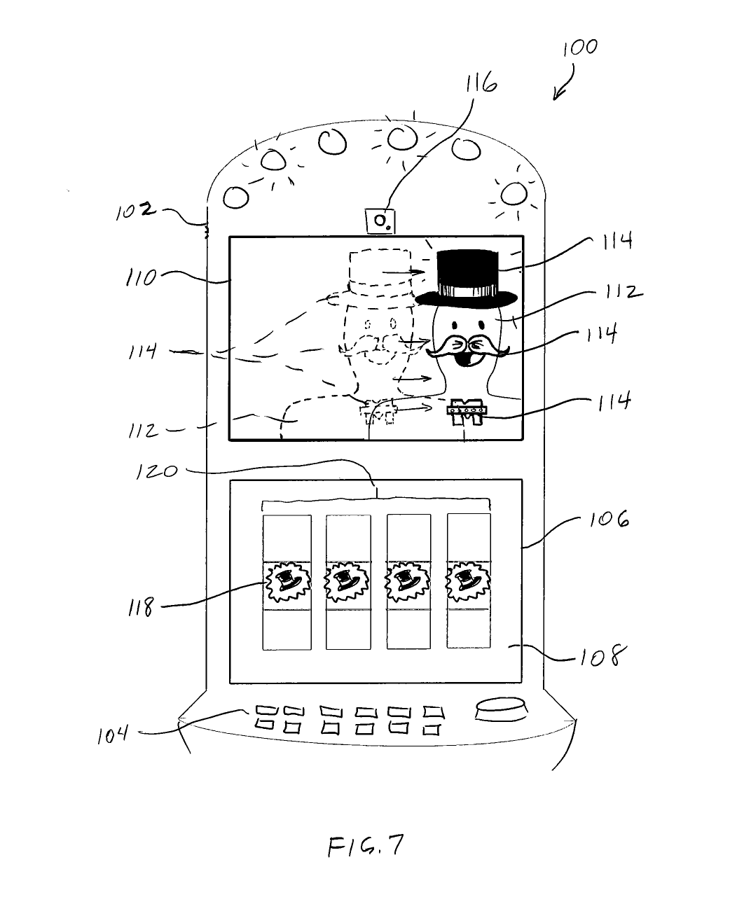

As the user 134 plays the wagering game at the gaming terminal 100, the user 134 will move around within the user operating position. Correspondingly, the minor image 112 displayed by the minor 130 will move and change. To maintain a degree of cohesiveness and realism, the user image enhancing graphics 114 are also updated and repositioned to maintain their relationship with the minor image 112. Movement of the user 134 to the left or right, or up and down, is detected at the motion tracking sensing device 116. The CPU 30 determines the new location of the user 134 and the corresponding new locations for the graphics 114 to align with the minor image 112 when viewed from the perspective of the user 134 at the new playing position. The new locations are output to the video display 132 so that the graphics 114 move with the minor image 112. As shown, for example, in FIG. 7, the user 134 and, correspondingly, the minor image 112 move to the right, and the displayed graphics 114 move along with the minor image 112. The movement of the graphics 114 gives the illusion of the graphics 114 being attached to the user 134.

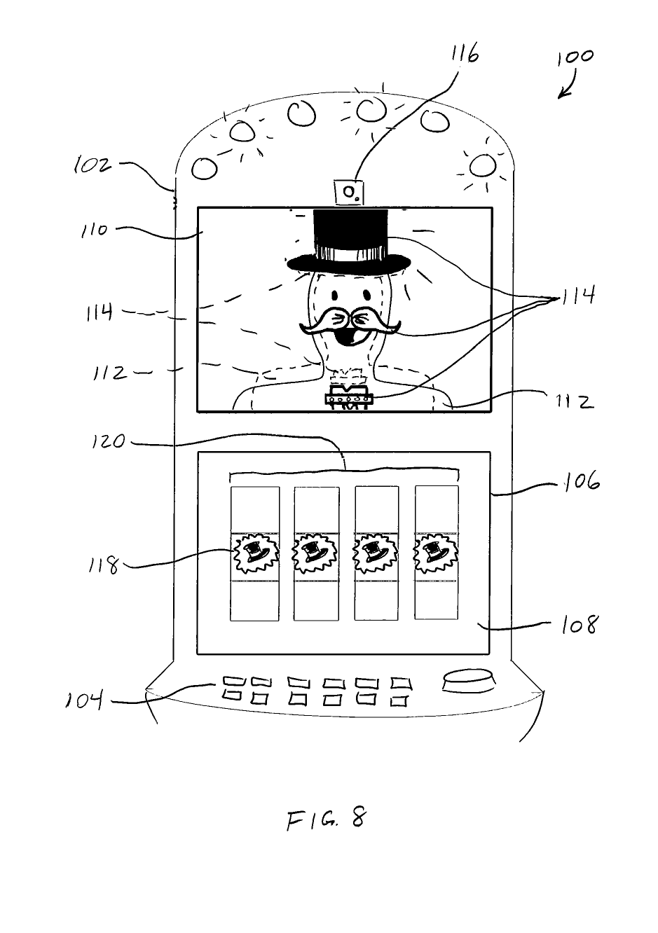

In addition to movements parallel to the secondary display area 110, the user 134 may move toward or away from the gaming terminal 100 so that the minor image 112 increase or decreases in size, respectively. Upon receiving data from the motion tracking sensing device 116, the CPU 30 may generate enlarged or reduced graphics 114 as appropriate and output the updated graphics 114 to the video display 132 so the graphics 114 appear to move in and out with the minor image 112. FIG. 8 illustrates the response of the gaming terminal 100 when the user moves closer to the secondary display area 110. The minor image 112 of the user 134 reflected by the minor 130 increases in size. At the same time, the CPU 30 generates enlarged graphics 114 for the hat, mustache and tie and updated graphics locations so that the graphics 114 are overlaid in the proper positions on the mirror image 112. As the user 134 moves away from the secondary display area 110, the CPU 30 will reduce the size of the graphics 114 as appropriate to maintain proper perspective and positioning with the mirror image 112.

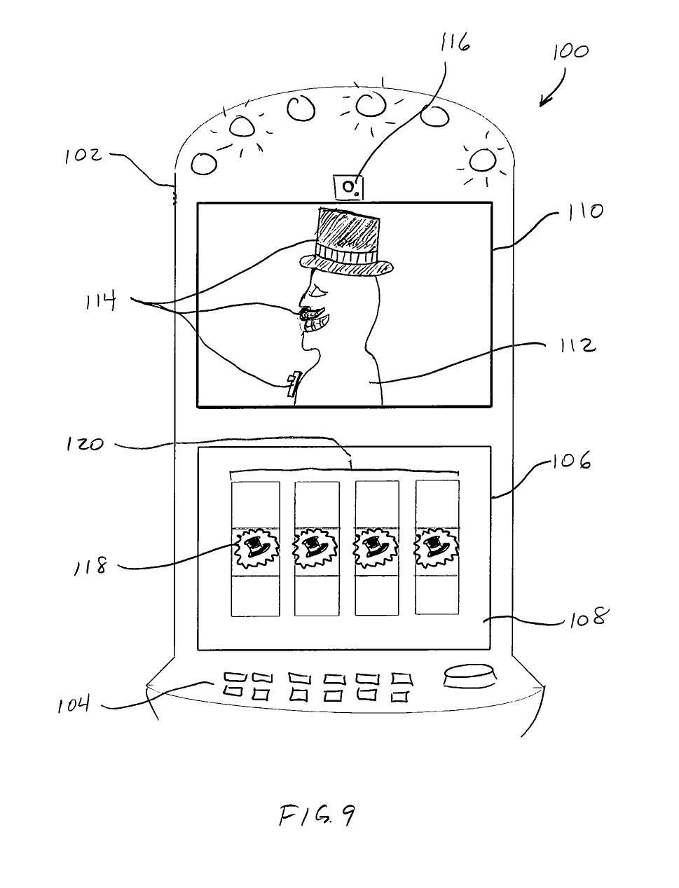

Depending on the sophistication of the motion tracking technology implemented at the gaming terminal 100, changes in the orientation of the user 134 may be detected, such as the user 134 turning their head or body from side-to-side. In FIG. 9, the user 134 has turned to the left so that the minor image 112 shows the right profile of the user 134. The CPU 30 generates graphics 114 for the hat, mustache and tie as mirror images of the right sides of the accessories and determines locations so that the accessories are positioned on the head, upper lip and collar, respectively, of the mirror image 112 of the user 134. Those skilled in the art that the user 134 will move though combinations of left and right, forward and back and reorientation movements while playing the wagering and bonus games at the gaming terminal 100, and that the CPU 30 will factor in all degrees of movement of the user 134 in determining the size, location and orientation of the graphics 114 to be overlaid on the mirror image 112 of the user 134 to provide the user 134 with the illusion that the overlaid graphics 114 are physical accessories associated with the body of the user 134 and move with the user 134 as closely as possible to appear to be worn or otherwise connected to the user 134.

The secondary display area 110 in accordance with the present disclosure capable of displaying graphics 114 overlaying a mirror image 112 of a user 134 may be implemented with alternative combinations of user image reproduction devices and user image enhancement devices. For example, the mirror 130 shown in FIG. 5 may be replaced with a video display device, such as an LCD or OLED video display, displaying a video mirror image of the user 134. In such embodiments, the gaming terminal 100 includes a video recording device, such as a video camera, for capturing the user 134 as the user 134 operates the gaming terminal 100 from within the user operating position. The video camera may be integrated into the motion tracking sensing device 116, or may be an additional device positioned proximate the secondary display area 110 to capture an image of the user 134 from a desired angle. The video camera outputs a video input signal of the user operating position to the CPU 30. Upon receiving the video input signal, the CPU 30 executes software instructions to generate a video output signal that is a minor image of the video input signal from the video camera. The video output signal is output to and displayed at the video output device behind the video display 132. The video mirror image is visible through the video display 132, and the user image enhancing graphics 114 are displayed on the video display 132 with sufficient light intensity to overlay the corresponding portions of the video mirror image of the user 134.

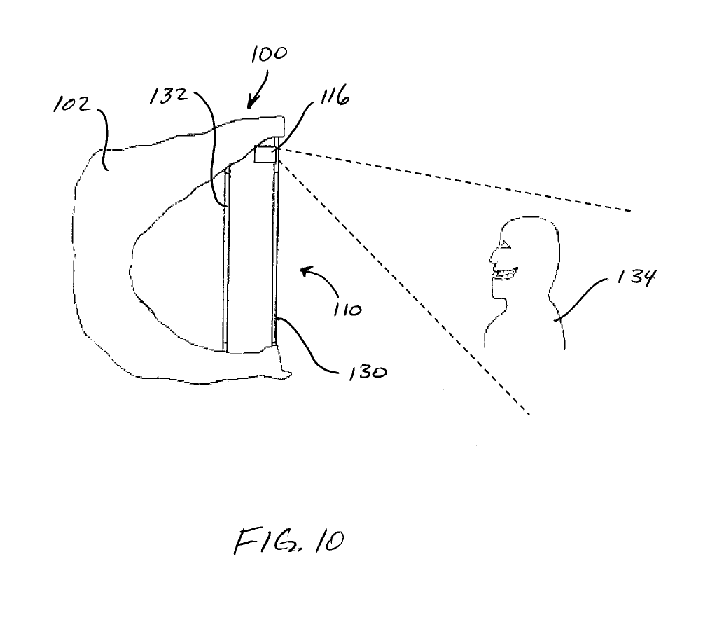

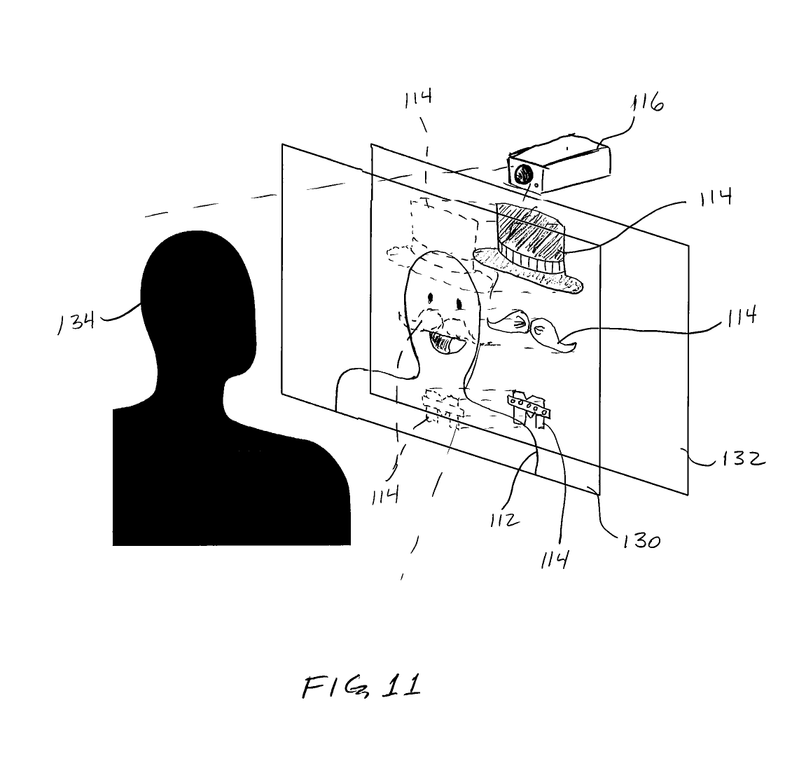

In further embodiments, the positions of the user image reproduction device and the user image enhancement device may be reversed while still displaying the minor image 112 of the user 134 with the graphics 114 overlaid. As shown, for example, in FIG. 10, the mirror 130 may be disposed at the front of the secondary display area 110 and the video display 132 may be located behind the minor 130 within the cabinet 102 of the gaming terminal 100. The mirror 130 may be a two-way, see-through or half-silvered-type minor that reflects light when no or low-intensity light is provided behind the mirror 130, but will allow higher intensity light to pass from behind when provided by the video display 132. Alternatively, the minor 130 may be replaced by a light transmissive video display through which the graphics 114 may be visible and overlaid on a video mirror image of the user 134. A touch screen device may be overlaid on the minor 130 or forward video display as discussed above, or may be integrated into the forward video display device, to detect touches by the user that are relevant to the execution of the game play. Referring to FIG. 11, the user 134 may see only the minor image 112 at the minor 130 when the video display 132 produces no or low-intensity light. When the video display 132 displays the graphics 114 with sufficient light intensity, the graphics 114 overlay the corresponding portions of the minor image 112 from the perspective of the user 134 and appear to be a part of the minor image 112. The motion tracking and graphics software stored at the main memory 32 may be configured to account for relative positions of the minor 130 and the video display 132 so that the graphics 114 are appropriately sized. Consequently, the generated graphics 114 may be larger when the video display 132 is behind the mirror 130 than when disposed in front of the mirror 130.

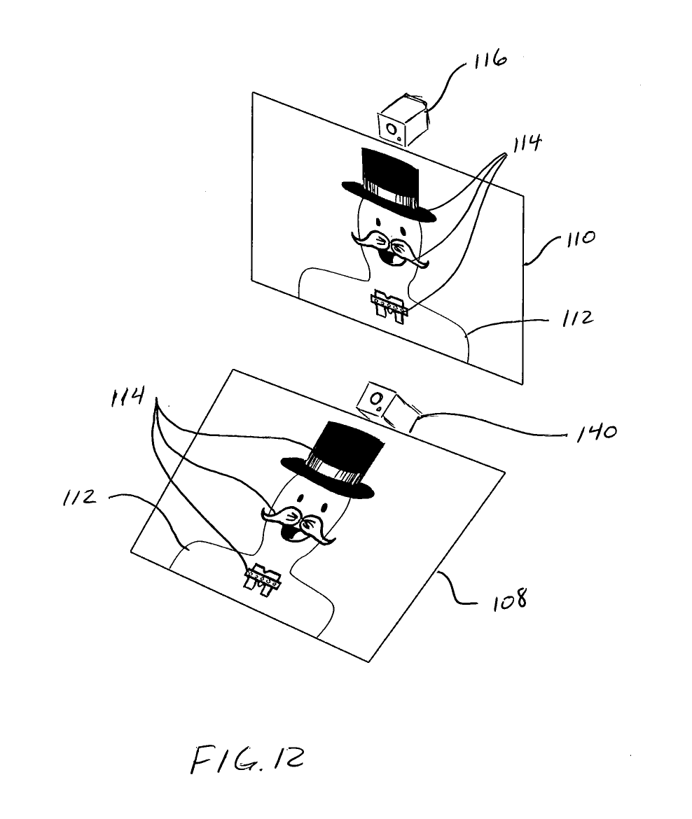

The above-described embodiments discuss a single secondary display area 110 providing the mirror image 112 of the user 134 with overlaid graphics 114, but the gaming terminal 100 may be provided with multiple displays similar to those described above having a user image reproduction device and a user image enhancement device. For example, FIG. 12 illustrates the primary display area 106 and the secondary display area 110 providing mirror images 112 of the user 134 with graphics 114. During execution of the primary wagering game, such as a slot machine game as shown in FIG. 4, graphics for the wagering game may be displayed at the primary display area 106. Where the minor 130 or other video display for the minor image 112 is behind the transmissive video display 132, the video display 132 may display the wagering game's graphics. When the bonus game is triggered and active for the user 134, the CPU 30 causes the video display 132 to allow the minor image 112 of the user 134 to be seen and to display the graphics 114 with the appropriate size, position and orientation for the minor image 112 of the user 134 from the lower position of the primary display area 106. After the bonus game is complete, the CPU 30 may return to having the primary display area 106 display the graphics for the primary wagering game.

The motion tracking and graphics generation software stored at the main memory 32 may be configured to interpret the user position and orientation information from the motion tracking sensing device 116 to generate the graphics 114 for both display areas 106, 110. Alternatively, the gaming terminal 100 may be provided with an additional motion tracking sensing device 140 disposed proximate the primary display area 106 and oriented to correspond to the position of the primary display area 106 in a similar manner that the motion tracking sensing device 116 is positioned relative to the secondary display area 110. In this arrangement, the software stored at the main memory 32 is configured to receive the user position and orientation information from both motion tracking sensing devices 116, 140 and generating the graphics 114 for the video display 132 at each display area 110, 106, respectively. In further embodiments, other display areas may be provided at the gaming terminal 100 to provide the desired game play and user image enhancement. For example, additional display areas may be provided on either side of the secondary display area 110 and oriented similar to a three-panel or tri-fold dressing mirror configuration to provide three minor image views of the user 134 with overlaid graphics 114. Other multi-display area configurations of the gaming terminal 100 will be apparent to those skilled in the art and are contemplated by the inventors as having use in gaming terminals 100 in accordance with the present disclosure.

The secondary display area 110 having a user image reproduction device and user image enhancement device as described above may be used in game play where in the user 134 is integrated into the game play to provide a customized personal experience for the user 134 at the gaming terminal. The following examples describe the user 134 and their minor image 112 being integrated into the game play for various bonus games, but those skilled in the art will understand that the user 134 may be integrated into the primary wagering games offered at the gaming terminal 100 as well. As discussed above in relation to FIG. 4, a bonus game may be initiated based on the occurrence of a triggering event in the primary wagering game, such as the appearance of a specified bonus combination of reel symbols 118 on one of the paylines in a slots game. When the bonus triggering event occurs, the gaming terminal 100 may enter a bonus game mode in which the bonus game is displayed at the secondary display area 110. In the embodiment illustrated in FIG. 4, the bonus game may entail awarding a new accessory to the user 134, such as the hat in the graphics 114 that is placed on the head of the minor image 112 and highlighted. The hat may be a new addition to accessories already awarded to the user 134 like the mustache and tie. After displaying the newly-awarded accessory to the user 134, the gaming terminal 100 may return to the execution of the primary wagering game. The accessories awarded to the user 134 may be retained as long as the user 134 continues playing at the gaming terminal 100, with additional accessories being awarded each time the bonus combination of reel symbols 118 occurs.

Where a player loyalty program is implemented and the user 134 identifies themselves via a player loyalty card or other identification device at the information reader 24, port 26 or other input device, the awarded accessories may be saved with the information for the user 134 and the previously-awarded accessories may be displayed for the user 134 during subsequent sessions at the gaming terminal 100 or other gaming terminals 10, 100 offering the same wagering game or other games wherein the user 134 is integrated into the game play. In such systems, the accessories may correspond to complimentary goods and services provided by the game operator to the users 134 at the gaming establishment, such as food and beverage credits, tournament admissions, rooming credits and the like. For example, accumulation of the hat, mustache and tie may entitle the user 134 to merchandise credit in a shop located at the gaming establishment that may be redeemed by presenting the player identification device at the time of purchase. Once the credit is redeemed, the corresponding accessories may be removed from the player's account of the user 134 and no longer displayed at a gaming terminal 100 until the accessories are again awarded to the user 134 when the bonus round is triggered.

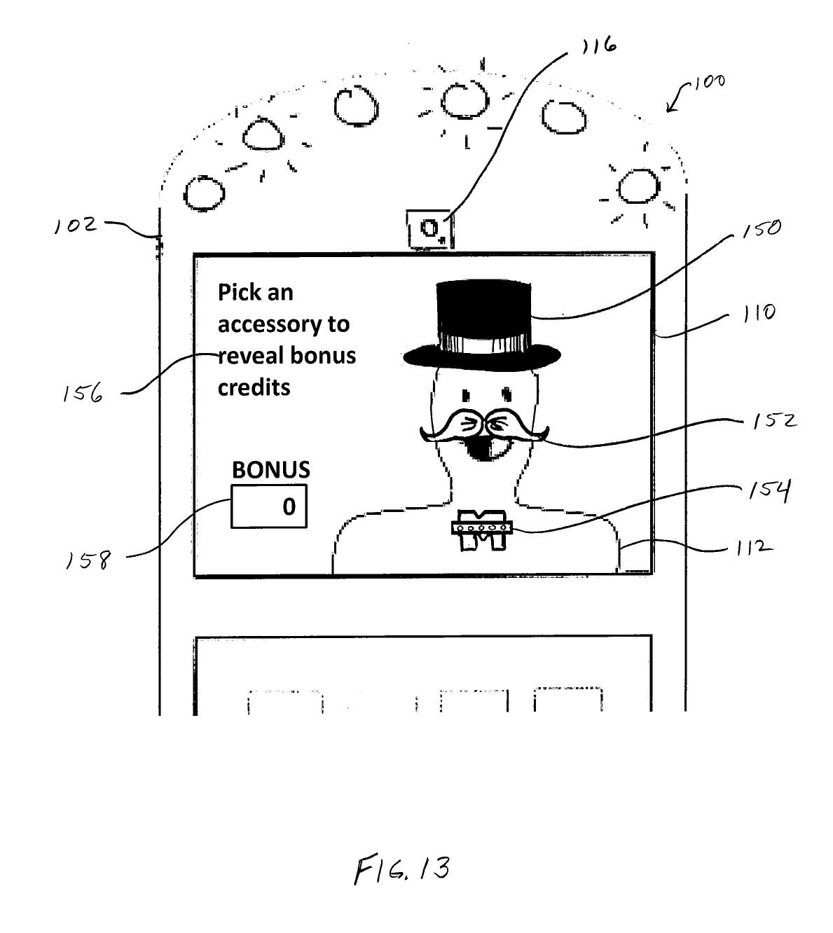

Alternative bonus award game play is contemplated where the user 134 participates in the bonus game by interacting with the minor image 112 and graphics 114. FIGS. 13-17 illustrate one embodiment of a bonus game at the secondary display area 110 in which the user 134 may select accessories associated with the minor image 112 to accumulate a bonus award. Referring to FIG. 13, upon the occurrence of the bonus game triggering event, the secondary display area 110 may display the mirror image 112 of the user 134 with associated enhancement graphics that may include, for example, accessories such as a hat 150, a mustache 152 and a tie 154. Additional and alternative accessories may be displayed and overlaid on the mirror image 112. Moreover, though only the head and shoulders of the user 134 are displayed, additional portions of the user 134 may be displayed with corresponding accessories overlaid where those portions are within the area that would cause a reflection in the minor 130, for example, that would be seen from the perspective of the user 134 and captured by the motion tracking sensing device 116. For example, the mirror image 112 may include a hand and arm of the user 134 when raised. The motion tracking sensing device 116 may detect the movement of the hand and arm into the user operating position. Upon receiving the position and orientation information for the arm and hand from the motion tracking sensing device 116, the CPU 30 may execute software instruction to generate corresponding graphics for accessories for the hand and arm, such as rings, watches, bracelets, cuff links and the like, that may be overlaid on the hand and arm via the video display 132 and integrated into the bonus game play.

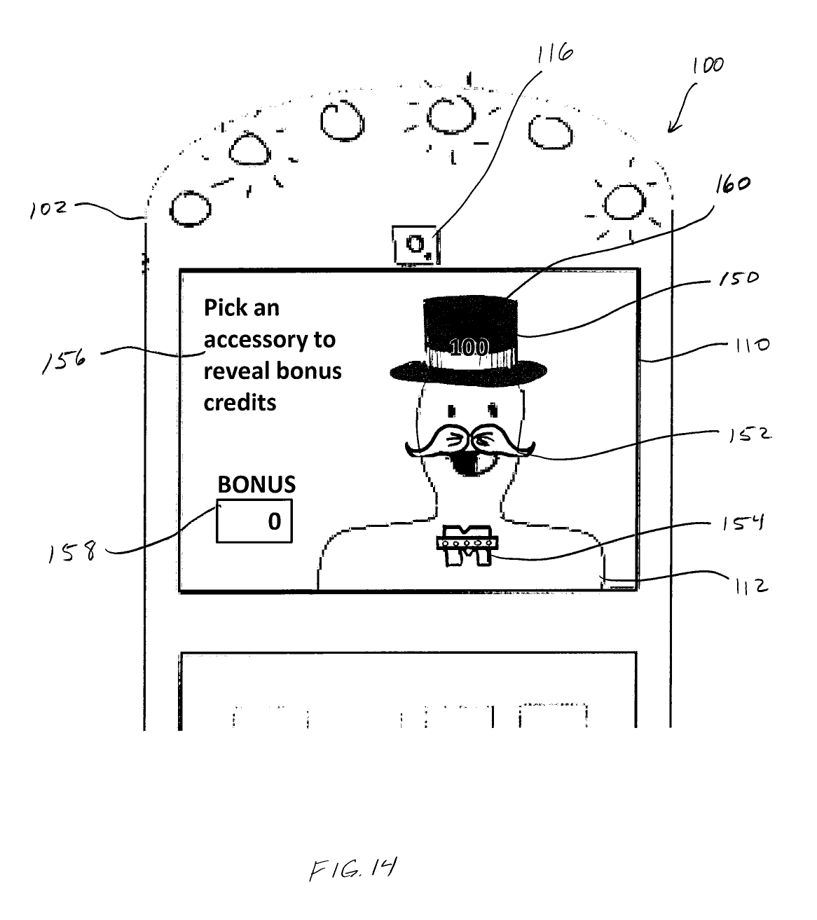

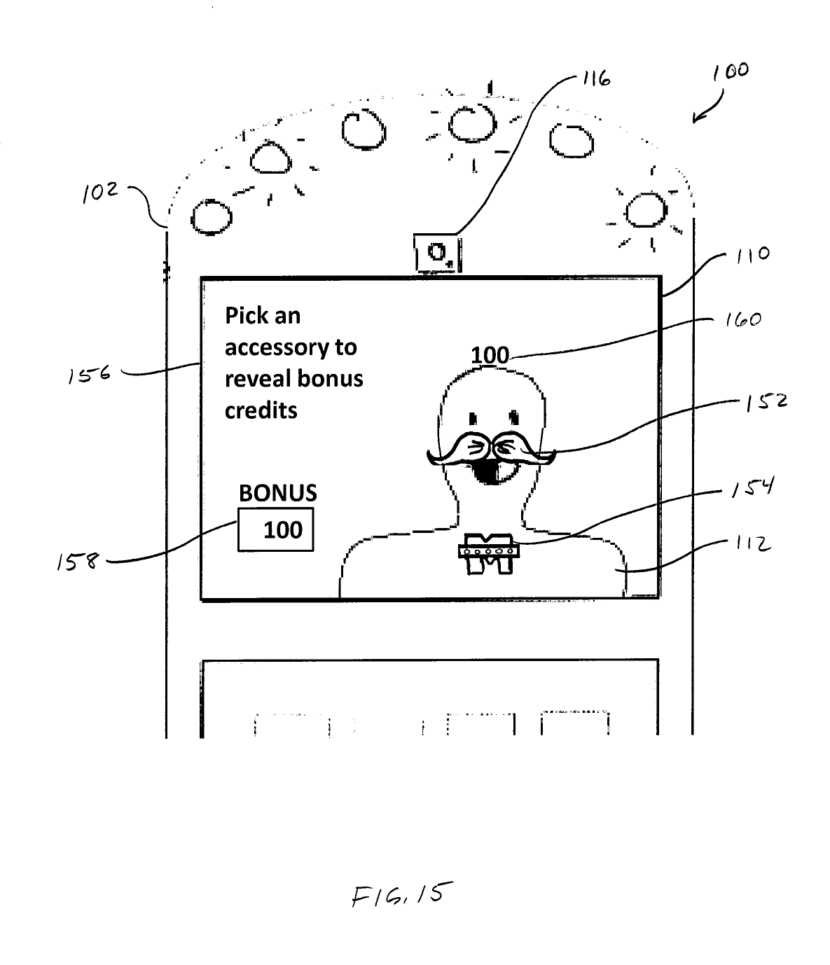

In addition to the mirror image 112 and graphics 150-154, the CPU 30 may generate and cause the video display 132 to display additional graphics related to the bonus game play, such as bonus game instruction graphics 156 and bonus total graphics 158. In the illustrated bonus game play, the user 134 may in turn select from the various accessories 150-154 overlaid on the minor image 112 to accumulate bonus awards. The selections may be made through any appropriate input mechanism provided for the bonus game, such as the buttons 104 and/or the touch screen 108 of the primary display area 106, or at the video display 132 where the video display 132 is a touch screen having soft keys at the accessories 150-154 and moving with the minor image 112 and accessories 150-154 to maintain their relationship with the accessories 150-154. Using the latter input method, the user 134 may make a bonus game selection by touching the video display 132 at one of the accessories, such as the hat 150. After the hat 150 is selected, the CPU 30 may cause the video display 132 to display a transition (fading as shown in FIG. 14) of the hat 150 to reveal a bonus award graphic 160 so that the hat 150 no longer overlays the mirror image 112 (FIG. 15). Once the bonus award graphic 160 is displayed, the CPU 30 may update a bonus total for the user 134 for the bonus game and display the updated total at the bonus total graphic 158.

In further alternatives, the motion tracking sensing device 116 and associated software may further integrate the hand motion of the user 134 into the bonus game play. The user 134 may be instructed to remove one of the accessories 150-154 to reveal a bonus game element graphic. The motion tracking sensing device 116 and motion tracking software may track the motion as the hand of the user 134 moves to and virtually grabs one of the accessories 150-154. When the user 134 then opens their hand, the selected accessory 150-154 may transition to a bonus element graphic indicting the result of the selection.

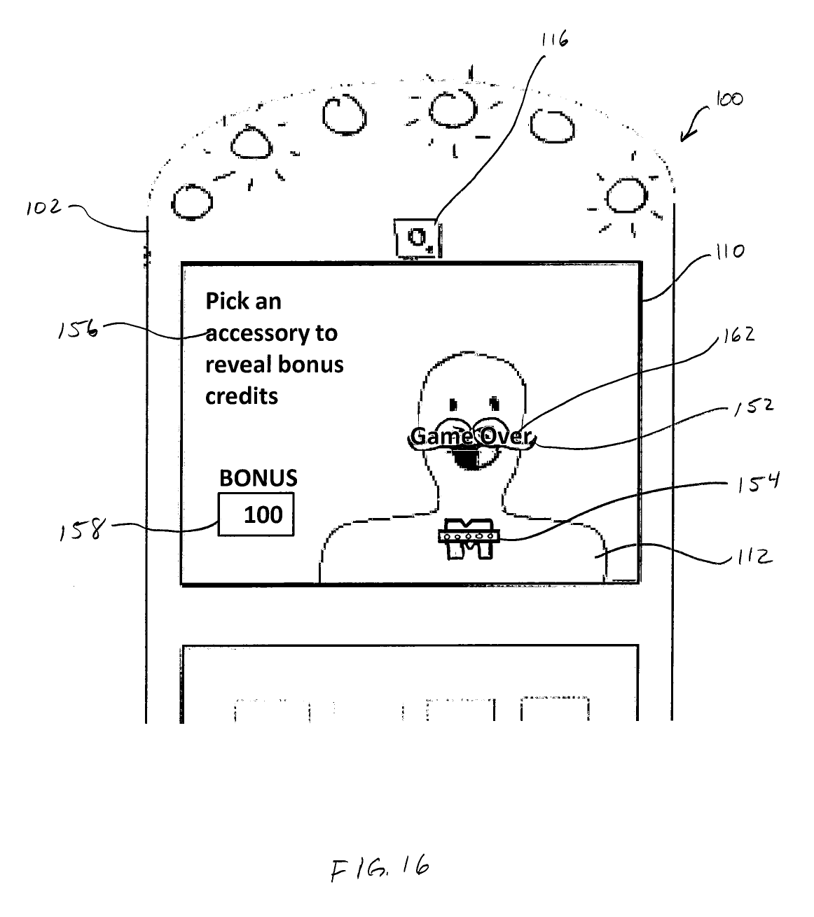

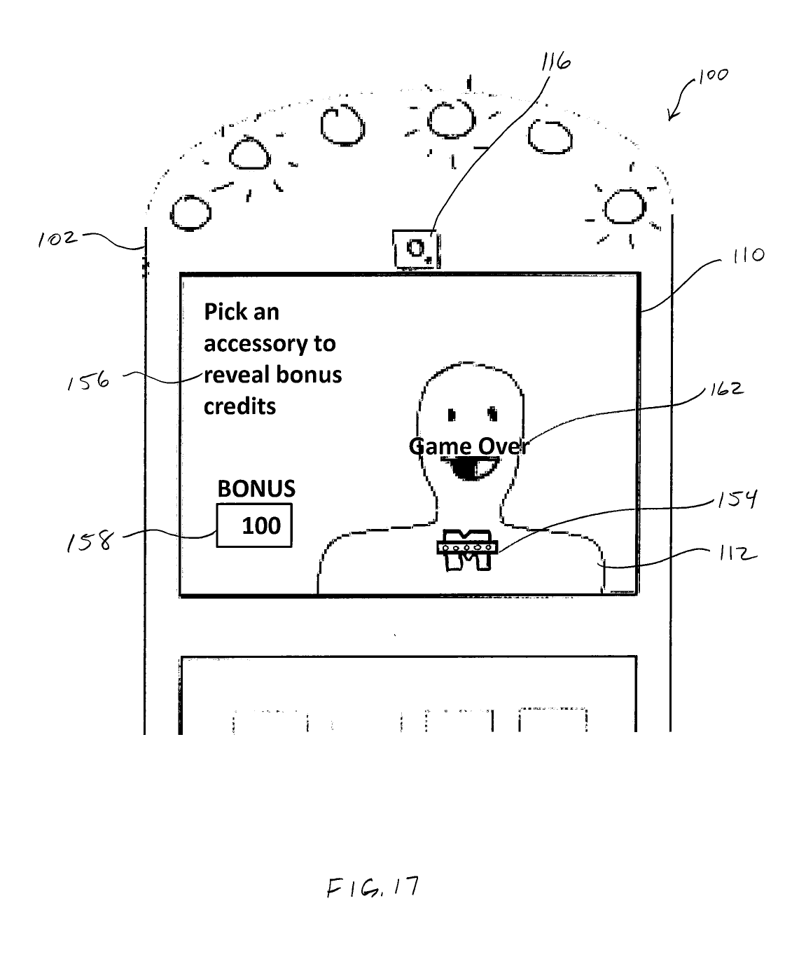

The bonus game may continue with the user 134 selecting from the remaining graphics 152, 154 until a bonus game ending triggering event occurs that will return control to the primary wagering game. In one bonus game, the user 134 may select a predetermined number of accessories 150-154 to arrive and a cumulative bonus total after which the gaming terminal 100 returns to the primary wagering game. In other bonus games, each of the accessories 150-154 may be associated with either a monetary bonus element or an end game element, and the user 134 may continue to pick accessories 150-154 until the user 134 picks two accessories 150-154 associated with matching end game elements, with the monetary bonus elements selected prior to the match being totaled for the bonus for the user 134. In a further alternative bonus game, the user 134 may select accessories 150-154 until selecting one of the end game elements. When the mustache 152 is selected by the user 134, the mustache 152 may transition by fading (FIG. 16) to reveal an end game element graphic 162 (FIG. 17). Once the end game element is selected, the CPU 30 may return control to the primary wagering game.

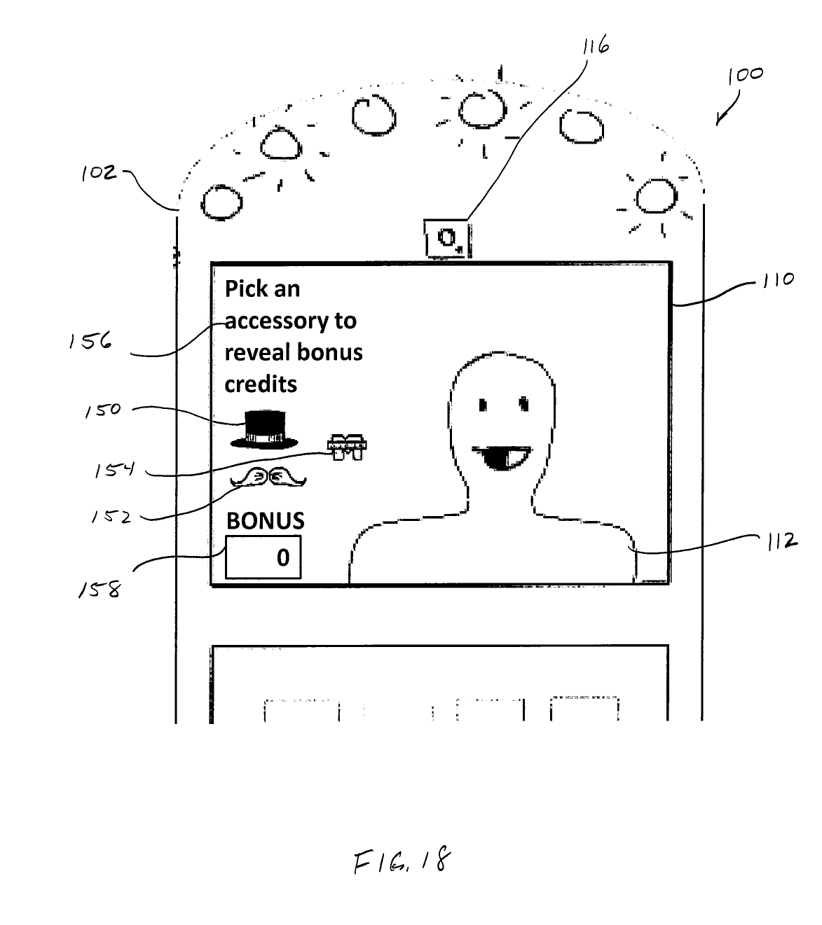

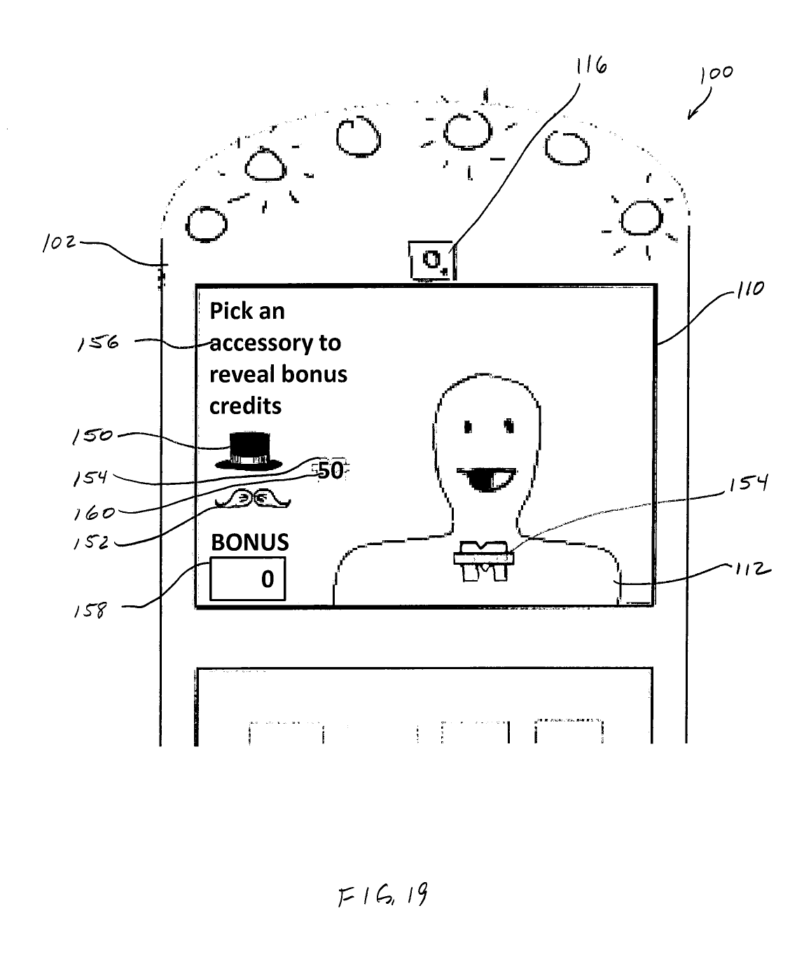

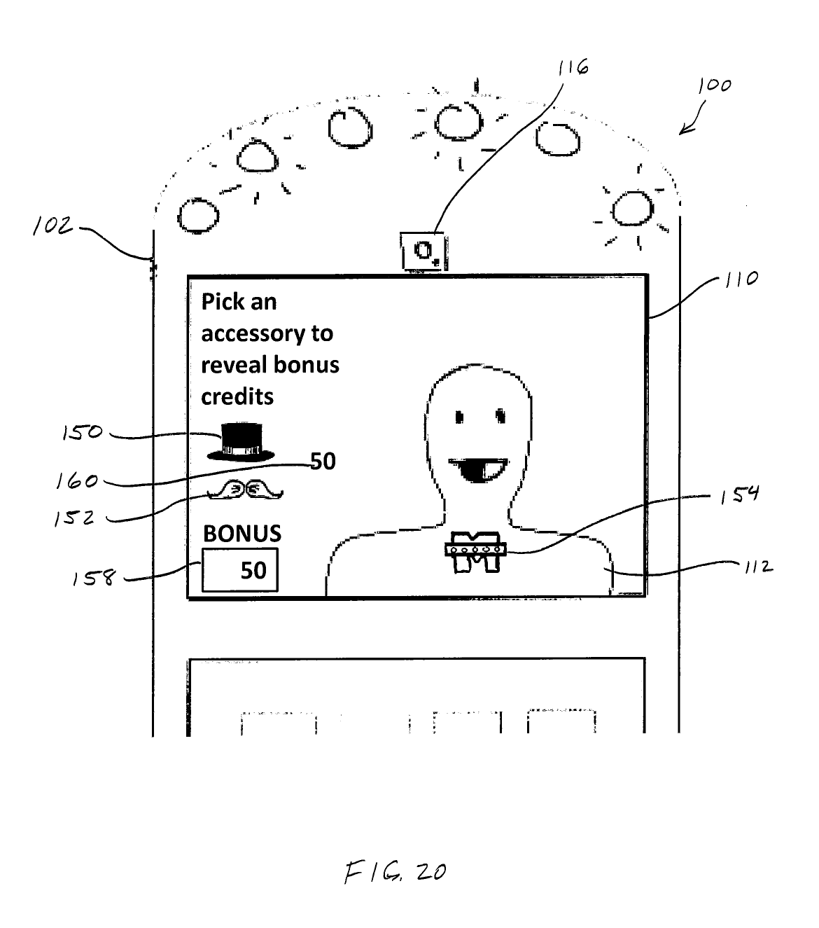

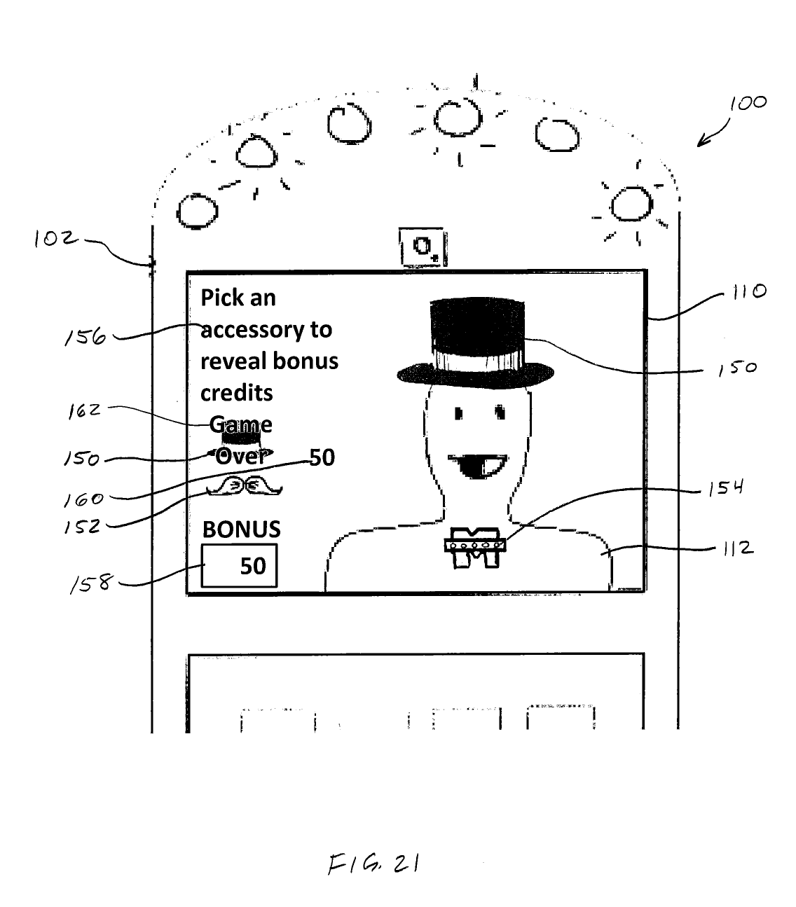

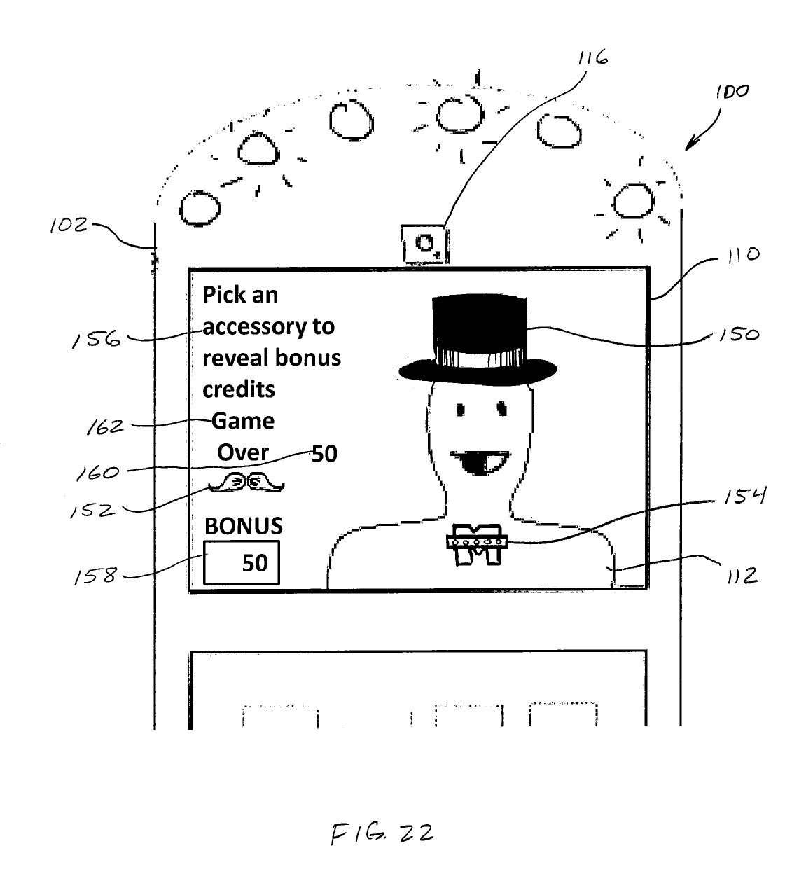

FIGS. 18-22 present an alternative bonus game play configuration for the gaming terminal 100. The bonus game play may be generally similar to the game play described above with respect to FIGS. 13-17 with the exception that the user 134 may select the accessories 150-154 to be overlaid onto the mirror image 112 and to reveal the associated monetary bonus award graphic 160 or end game element graphic 162. As shown in FIG. 18, the available accessories 150-154 may be displayed on the video display 132 along with the bonus game instruction graphics 156 and bonus total graphics 158, and not overlaying the mirror image 112. When one of the accessories 150-154, such as the tie 154, is selected by the user 134, the accessory graphic 154 transitions (fading in and out as shown in FIG. 19) from being off the mirror image 112 to being overlaid on the minor image 112 at the appropriate location. As the tie 154 fades, the associated bonus award graphic is displayed in its place and the bonus amount is added to the bonus total and displayed at the bonus total graphics 158, and the tie 154 appears on at the collar of the mirror image 112 as illustrated in FIG. 20. The bonus game may have similar termination conditions as those discussed above. Consequently, the bonus game may terminate after the user 134 selects a specified number of accessories 150-154, selects matching end game element graphics 162, or selects a single end game element graphic 162 (See transition of FIGS. 21 and 22), depending on the particular configuration of the bonus game play.

During the execution of the bonus game play depicted in FIGS. 13-22, the user 134 may move to positions where the minor image 112 overlaps with the bonus game graphics 156-162. The CPU 30 may interpret the information from the motion tracking sensing device 116 to determine that such overlapping is occurring. The CPU 30 may be configured in various ways to adjust the display at the secondary display area 110 so that the game play is not interrupted. In some implementations, the display of the bonus game graphics 156-162 may be maintained and the user image enhancement graphics 114 may be faded so that the bonus game graphics 156-162 appear to be in front of the minor image 112 and accompanying graphics 114. Alternatively, the display of the user image enhancement graphics 114 may be maintained while the bonus game graphics 156-162 are faded so that the minor image 112 appears to be in front of the bonus game graphics 156-162. As a further option, the CPU 30 may determine new locations for the bonus game graphics 156-162 in portions of the secondary display area 110 that are not occupied by the mirror image 112 and user image enhancement graphics 114, and cause the bonus game graphics 156-162 to be displayed in those locations. When the graphics 156-162 are moved, any corresponding soft keys on the video display 132 associated with the graphics 156-162 will be moved to the new locations as well so that the user 134 can continue to execute the bonus game play. Additional configurations accounting for the overlapping of the mirror image 112 and the bonus game graphics 156-162 will be apparent to those skilled in the art and are contemplated by the inventors as having use in gaming terminals 100 and game play in accordance with the present disclosure.

The gaming terminals 100 and associated game play disclosed herein integrate the player's physical characteristics and movements into the display and game play at the gaming terminals 100. Consequently, each player has a unique and personalized game play experience that is tailored to their appearance and movements at the gaming terminal 100. This integration should enhance the player's experience at the gaming terminal 100, making the gaming experience more memorable and more likely to cause the player to choose to return to the gaming terminal for subsequent gaming sessions.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming system comprising:
a motion tracking sensing device;
a user image reproduction device configured to display a mirror image of a user operating the gaming system;
a user image enhancement display device disposed in proximity to the user image reproduction device; and
one or more memory devices storing instructions that, when executed by one or more processors, cause the gaming system to:
sense, via the motion tracking sensing device, a first relative position of the user;
generate first graphical images and first graphical image locations based on the sensed first relative position of the user; and
output the first graphical images at the first graphical image locations on the user image enhancement display device so that the graphical images overlay corresponding portions of the mirror image of the user when viewed from the sensed first relative position of the user.

2. The gaming system of claim 1, wherein the instructions cause the gaming system to:
sense a second relative position of the user when the user moves from the first relative position to the second relative position;
generate second graphical images and second graphical image locations based on the second relative position of the user; and
output the second graphical images at the second graphical image locations on the user image enhancement display device so that the second graphical images overlay corresponding portions of the mirror image of the user operating the gaming system when viewed from the second relative position of the user.

3. The gaming system of claim 1, wherein the instructions cause the gaming system to:
sense a first user orientation of the user when the user is at the first relative position;
sense a second user orientation of the user when the user moves from the first user orientation to the second user orientation;
generate second graphical images based on the second user orientation of the user; and
output the second graphical images on the user image enhancement display device so that the second graphical images overlay corresponding portions of the mirror image of the user when viewed from the first relative position of the user.

4. The gaming system of claim 1, wherein the user image reproduction device comprises a mirror.

5. The gaming system of claim 1, further including a video camera aimed at a user operating position of the gaming system and wherein the user image reproduction device comprises a video output device, and wherein instructions cause the gaming system to:
receive a video input signal of the user operating position from the video camera;
generate a video output signal that is a minor image of the video input signal from the video camera; and
output the video output signal on the video output device.

6. The gaming system of claim 1, wherein the user image reproduction device comprises a light transmissive device disposed between the user image enhancement display device and a user operating position of the gaming system so that the first graphical images output by the user image enhancement display device are visible through the light transmissive device to overlay the corresponding portions of the mirror image of the user when viewed from the first relative position of the user.

7. The gaming system of claim 1, wherein the user image enhancement display device comprises a light transmissive video display device allowing partial light transmission from behind the light transmissive video display device and disposed between the user image reproduction device and a user operating position of the gaming system so that the minor image of the user image reproduction device is visible through the light transmissive video display device with the first graphical images output by the light transmissive video display device overlaying the corresponding portions of the minor image of the user when viewed from the first relative position of the user.

8. A computer-implemented method in a gaming system, the method comprising:
displaying a minor image of a user operating the gaming system on a user image reproduction device of the gaming system;
sensing, via an input device, a first relative position of the user;
generating, by one or more processors, first graphical images and first graphical image locations based on the sensed first relative position of the user; and
outputting the first graphical images at the first graphical image locations at an output device so that the graphical images overlay corresponding portions of the mirror image of the user when viewed from the sensed first relative position of the user.

9. The computer-implemented method of claim 8, further comprising:
sensing a second relative position of the user when the user moves from the first relative position to the second relative position;
generating second graphical images and second graphical image locations based on the second relative position of the user; and
outputting the second graphical images at the second graphical image locations at the output device so that the second graphical images overlay corresponding portions of the mirror image of the user when viewed from the second relative position of the user.

10. The computer-implemented method of claim 8, further comprising:
sensing a first user orientation of the user when the user is at the first relative position;
sensing a second user orientation of the user when the user moves from the first user orientation to the second user orientation;
generating second graphical images based on the second user orientation of the user; and
outputting the second graphical images at the output device so that the second graphical images overlay corresponding portions of the minor image of the user when viewed from the first relative position of the user.

11. The computer-implemented method of claim 8, wherein the input device comprises a video camera and the user image reproduction device comprises a video output device, the method further comprising:
aiming the video camera at a user operating position of the gaming system;
receiving a video input signal of the user operating position from the video camera;
generating a video output signal that is a mirror image of the video input signal from the video camera; and
outputting the video output signal on the video output device.

12. The computer-implemented method of claim 8, wherein the output device comprises a light transmissive device allowing partial light transmission from behind the light transmissive device, the method further comprising disposing the light transmissive device between the output device and a user operating position of the gaming system so that the first graphical images output by the output device are visible through the light transmissive device to overlay the corresponding portions of the mirror image of the user when viewed from the first relative position of the user.

13. The computer-implemented method of claim 8, wherein the output device comprises a light transmissive video display device allowing partial light transmission from behind the light transmissive video display device and, the method further comprising disposing the light transmissive video display device between the user image reproduction device and a user operating position of the gaming system so that the minor image of the user image reproduction device is visible through the light transmissive video display device with the first graphical images output by the light transmissive video display device overlaying the corresponding portions of the minor image of the user when viewed from the first relative position of the user.

14. A gaming system comprising:
a mirror for displaying a mirror image of a user operating the gaming system;
a motion tracking sensing device;
a user image enhancement display device disposed in proximity to the mirror; and
one or more memory devices storing instructions that, when executed by one or more processors, cause the gaming system to:
sense, via the motion tracking sensing device, a first relative position of the user;
generate first graphical images and first graphical image locations based on the sensed first relative position of the user; and
output the first graphical images at the first graphical image locations on the user image enhancement display device so that the graphical images overlay corresponding portions of the mirror image of the user when viewed from the sensed first relative position of the user.

15. The gaming system of claim 14, wherein the instructions cause the gaming system to:
sense a second relative position of the user when the user moves from the first relative position to the second relative position;
generate second graphical images and second graphical image locations based on the second relative position of the user; and
output the second graphical images at the second graphical image locations on the user image enhancement display device so that the second graphical images overlay corresponding portions of the mirror image of the user when viewed from the second relative position of the user.

16. The gaming system of claim 14, wherein the instructions cause the gaming system to:
sense a first user orientation of the user when the user is at the first relative position;
sense a second user orientation of the user when the user moves from the first user orientation to the second user orientation;
generate second graphical images based on the second user orientation of the user; and
output the second graphical images on the user image enhancement display device so that the second graphical images overlay corresponding portions of the mirror image of the user when viewed from the first relative position of the user.

17. The gaming system of claim 14, wherein the minor comprises a two-way mirror allowing partial light transmission from behind the two-way minor and disposed between the user image enhancement display device and a user operating position of the gaming system so that the first graphical images output by the user image enhancement display device are visible through the two-way mirror to overlay the corresponding portions of the mirror image of the user when viewed from the first relative position of the user.

18. The gaming system of claim 14, wherein the user image enhancement display device comprises a light transmissive video display device allowing partial light transmission from behind the light transmissive video display device and disposed between the minor and a user operating position of the gaming system so that the minor image of the minor is visible through the light transmissive video display device with the first graphical images output by the light transmissive video display device overlaying the corresponding portions of the minor image of the user when viewed from the first relative position of the user.

19. The gaming system of claim 18, wherein the light transmissive video display device comprises a touch screen responsive to contact by the user on a front surface of the light transmissive video display device, wherein the instructions cause the gaming system to:
generate bonus game graphical images and bonus game graphical image locations associated with a bonus game of the gaming system; and
output the bonus game graphical images at the bonus game graphical image locations on the light transmissive video display device so that the bonus game graphical images overlay corresponding portions of the mirror image of the user when viewed from the sensed first relative position of the user if the bonus game graphical images overlap with the minor image.

20. The gaming system of claim 19, wherein the instructions cause the gaming system to:
sense a second relative position of the user when the user moves from the first relative position to the second relative position;
generate second graphical images and second graphical image locations based on the second relative position of the user;
output the second graphical images at the second graphical image locations on the light transmissive video display device so that the second graphical images overlay corresponding portions of the mirror image of the user when viewed from the second relative position of the user; and
output the bonus game graphical images at the bonus game graphical image locations on the light transmissive video display device.
